(19) United States
(12) Patent Application Publication
(10) Pub. No.: US 2012/0170924 A1
(43) Pub. Date: Jul. 5, 2012

(54) CAMERA MODULE

(75) Inventor: WEI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/234,404

(22) Filed: Sep. 16, 2011

(30) Foreign Application Priority Data
Dec. 29, 2010 (CN) 201010612693.1

(51) Int. Cl. G03B 17/00

(52) U.S. Cl. 396/529

(57) ABSTRACT

A camera module includes a printed circuit board and a lens mounted on the printed circuit board. The printed circuit board includes a main body having a regular rectangular shape, for example, and a marked portion formed on the main body. The main body has a first symmetrical axis lengthwise along the rectangular structure of the main body, and a second symmetrical axis perpendicular to the first symmetric axis. The marked portion is visible from the top or the bottom of the printed circuit board, which aids in the assembly of the printed circuit board.

### BACKGROUND

1. Technical Field

The present disclosure relates to camera modules and, particularly, to a camera module equipped with a printed circuit board.

2. Description of Related Art

A commonly used camera module generally includes a lens, a printed circuit board and an electric connector. The lens and the electric connector are mounted on the back and front of the printed circuit board, respectively, and both are electrically connected to the printed circuit board. Since many printed circuit boards all have the same regular and symmetrical shapes, they are easy to be misassembled. During the assembly process, people need to find the mark formed on the preassembled printed circuit board first, and then to assemble the printed circuit board, thereby wasting time and reducing the efficiency of assembly. Thus, there is a need to form a mark on the back surface of the printed circuit board, for facilitating the assembly of the printed circuit board.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an exploded, isometric view of a first embodiment of a camera module, in accordance with the present disclosure.

FIG. 2 is similar to FIG. 1, but viewed from another aspect.

FIG. 3 is a top view of a printed circuit board of the camera module shown in FIG. 1.

FIG. 4 is a top view of a second embodiment of the printed circuit board of the camera module, in accordance with the present disclosure.

FIG. 5 is a top view of a third embodiment of the printed circuit board of the camera module, in accordance with the present disclosure.

FIG. 6 is a top view of a fourth embodiment of the printed circuit board of the camera module, in accordance with the present disclosure.

FIG. 7 is a top view of a fifth embodiment of the printed circuit board of the camera module, in accordance with the present disclosure.

FIG. 8 is a top view of a sixth embodiment of the printed circuit board of the camera module, in accordance with the present disclosure.

### DETAILED DESCRIPTION

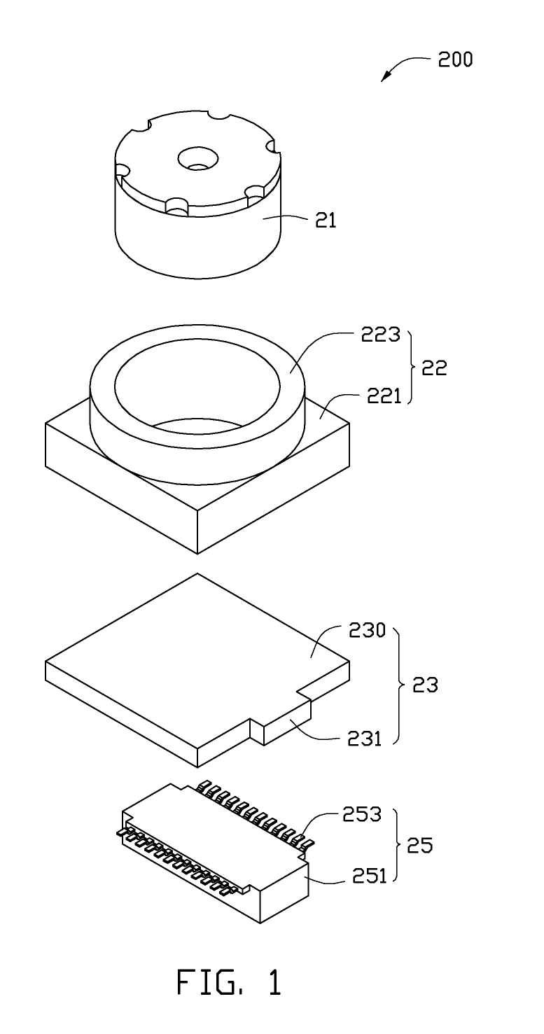

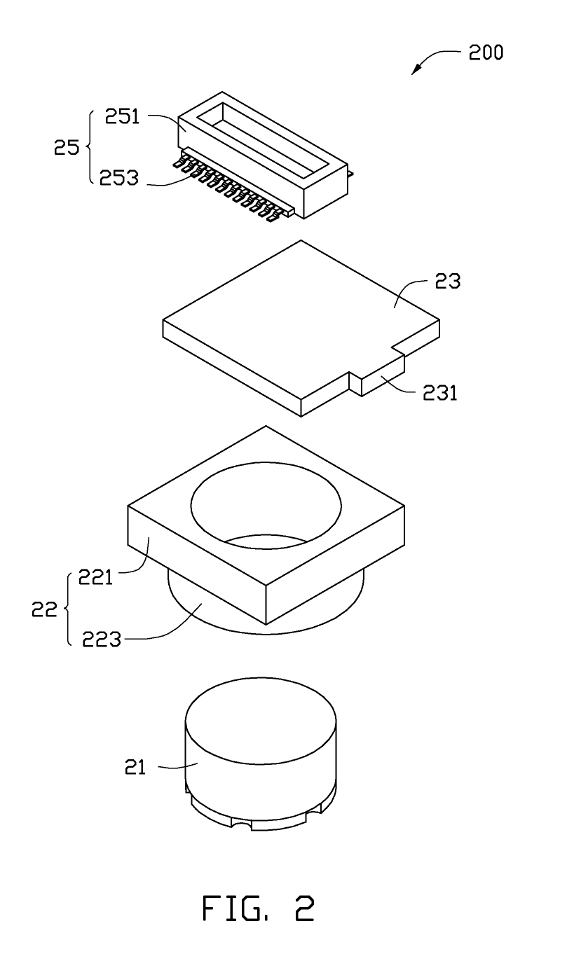

Referring to FIGS. 1 through 3, a first embodiment of a camera module 200 includes a lens 21, a lens holder 22 for assembling the lens 21, a printed circuit board 23 and an electronic connector 25. The lens holder 22 includes a substantially square mounting portion 221 and a substantially cylindrical lens barrel 223 formed on the mounting portion 221.

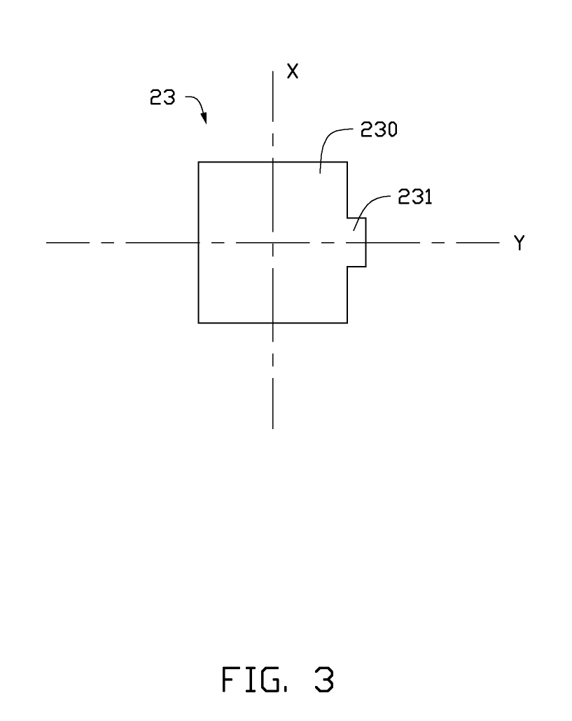

The printed circuit board 23 includes a main body 230 and a marked portion 231 formed on an edge of the main body 230. The main body 230 of the printed circuit board 23 without the marked portion 231 is regular in shape, and the shape of the main body 230 is substantially rectangular. FIG. 3 shows a first symmetrical axis X lengthwise along the rectangular structure of the main body 230, and a second symmetrical axis Y perpendicular to the first symmetric axis X. The marked portion 231 is also substantially rectangular. Since there is only one marked portion 231 positioned on the line of the symmetrical axis Y, thus, the outline or silhouette of the printed circuit board 23 is asymmetrical about the first symmetrical axis X. It is to be understood that, the main body 230 can also be in any other symmetrical shape, such as circular, or diamond shaped.

The electronic connector 25 includes a substantially rectangular base portion 251 and two rows of connecting pins 253 along the longer sides of the base portion 251 for electrically connecting with the printed circuit board 23. In assembly, the lens 21 is assembled within the lens barrel 223 of the lens holder 22. The lens holder 22 and the electronic connector 25 are then mounted on opposite surfaces of the printed circuit board 23, to finish the assembly of the camera module 200.

During the assembly process of the camera module 200, an assembler generally looks down toward the camera module 200, and the presence of the marked portion 231 makes it easier for the assembler to judge whether or not the printed circuit board 23 is positioned properly for assembly. In other words, the assembler does not need to take the time to turn the printed circuit board 23 over, or turn it around to find the marked portion 231, since the position of the marked portion 231 is obvious, regardless of whether the printed circuit board 23 is viewed from the top or the bottom. In this situation, the assembler can assemble the printed circuit board 23 with the lens holder 22 and the electronic connector 25 more quickly. The efficiency of assembly of the camera module 200 is enhanced, and the possibility of misassembly of the printed circuit board 23 is also reduced.

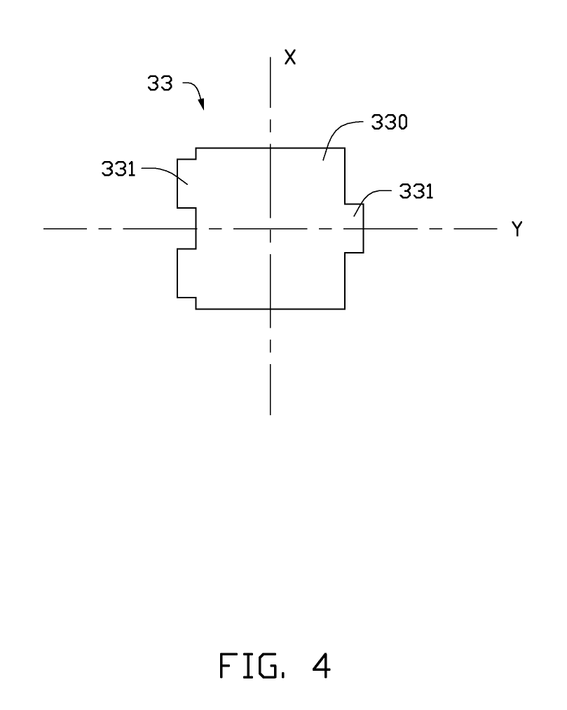

Referring to FIG. 4, a top view of a second embodiment of the printed circuit board 33 is shown. The second embodiment of the printed circuit board 33 has a structure similar to that of the first embodiment of the printed circuit board 23 of FIG. 3. The printed circuit board 33 includes a main body 330 and three marked portions 331. Two of the marked portions 331 are on one edge of the main body 330, and positioned at the left side of the first symmetrical axis X of the main body 330. The remaining marked portion 331 is formed on the middle portion of the other opposite edge of the main body 330, and at the right side of the first symmetrical axis X of the main body 330. The asymmetry of this configuration allows the same efficiency in assembly of the printed circuit board 33. It is to be understood that, the quantity of the marked portions 331 can also be more than three, so long as the number of marked portions 331 on one side is different to the number of marked portions 331 on the opposite side.

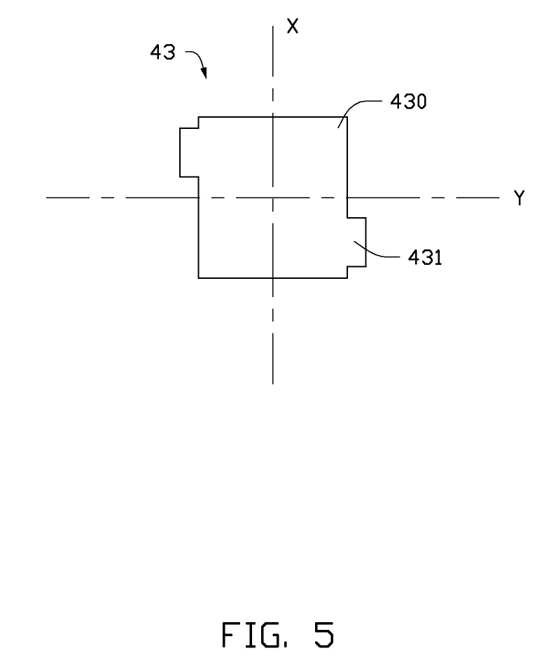

Referring to FIG. 5, a top view of a third embodiment of the printed circuit board 43 is shown. The third embodiment of the printed circuit board 43 includes a main body 430 and two marked portions 431. A straight line formed between the two marked portions 431 is not parallel to the second symmetrical axis Y of the main body 430, and the straight line crosses the symmetrical axis Y obliquely. In this embodiment, the two marked portions 431 have same shapes with different positions when compared to each other, thereby providing the assembler the same efficiency in assembly.

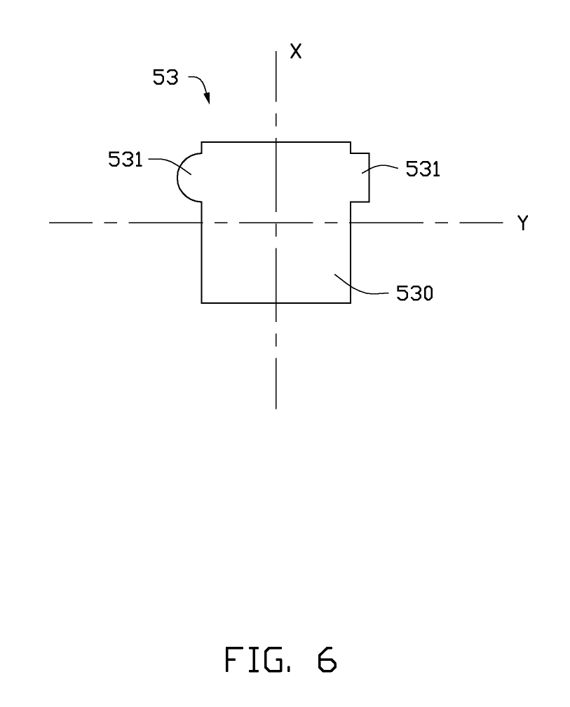

Referring to FIG. 6, a top view of a fourth embodiment of the printed circuit board 53 is shown. The fourth embodiment of the printed circuit board 53 includes a main body 530 and two marked portions 531, but the shapes of the two or more marked portions 531 are all different. The two marked portions 531 may be symmetrically positioned around the axis X, at two sides of the main body 530. One marked portion 531 may be semicircular, and positioned at the left side surface of the main body 530, the other marked portion 531 may be square or rhomboid in shape, and positioned at the right side surface of the main body 530.

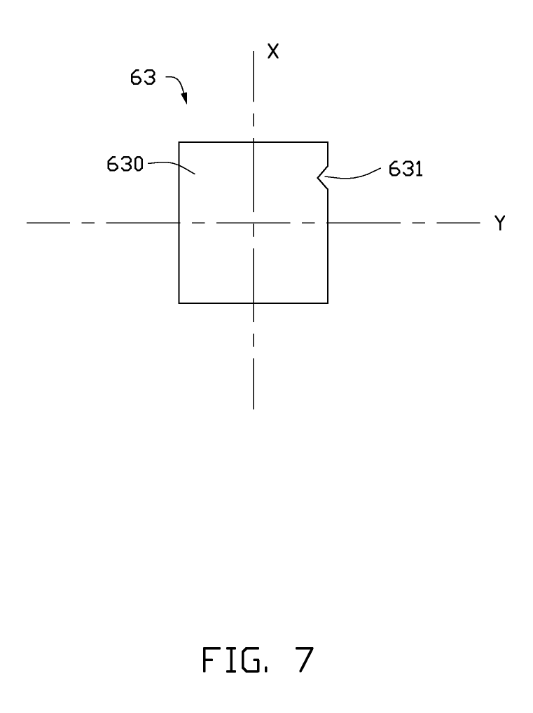

Referring to FIG. 7, a top view of a fifth embodiment of the printed circuit board 63 is shown. The fifth embodiment of the printed circuit board 63 includes a main body 630 and a notch or indentation (a marked portion 631) at one edge of the main body 630. In this embodiment, the marked portion 631 goes all the way through the printed circuit board 63, and the marked portion 631 is not a blind hole.

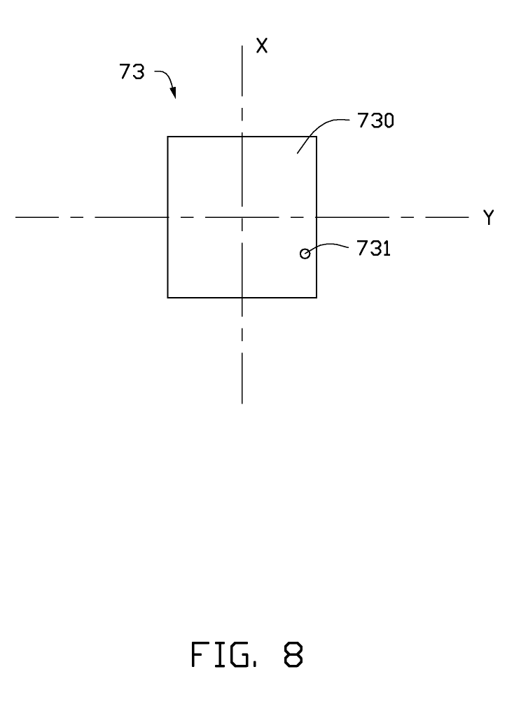

Referring to FIG. 8, a top view of a sixth embodiment of the printed circuit board 73 is shown. The sixth embodiment of the printed circuit board 73 includes a main body 730 and a small through hole (a marked portion 731) defined through the main body 730 and positioned adjacent to one side of the main body 730. In this embodiment, the marked portion 731 is a circular through hole positioned adjacent to the right side surface of the main body 730. The marked portion 731 can also have another simple shape, such as square, or triangular or the like.

Although numerous characteristics and advantages of the disclosure have been set forth in the foregoing description, together with details of the structure and function of the embodiment, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A camera module, comprising:
a printed circuit board; and
a lens mounted on the printed circuit board;
wherein, the printed circuit board comprises a main body having a regular shape, and a marked portion formed on the main body; the main body has a first symmetrical axis lengthwise along the structure of the main body, and a second symmetrical axis perpendicular to the first symmetric axis;
the marked portion being visible from the top or the bottom of the printed circuit board.

2. The camera module of claim 1, wherein the camera module further comprises a lens holder mounted on the printed circuit board, the lens holder comprises a mounting portion, a lens barrel formed on the mounting portion, and the lens is assembled within the lens barrel.

3. The camera module of claim 2, wherein the camera module further comprises an electronic connector, the lens holder and the electronic connector are oppositely mounted on the top and bottom surfaces of the printed circuit board, respectively.

4. The camera module of claim 1, wherein the number of the marked portion is one, and the marked portion is positioned at one side of the first symmetrical axis of the main body, and an outline of the printed circuit board is asymmetrical about the first symmetrical axis.

5. The camera module of claim 4, wherein the marked portion is substantially square, circular or diamond in shape.

6. The camera module of claim 1, wherein the number of the marked portions is two, and a straight line formed between the two marked portions is not parallel to the second symmetrical axis of the main body, and the straight line crosses the symmetrical axis obliquely.

7. The camera module of claim 6, wherein one of the two marked portions is positioned adjacent to an upper end of the left side surface of the main body, and the other one of the two marked portions is positioned adjacent to a bottom end of the right side surface of the main body.

8. The camera module of claim 6, wherein the two marked portions have different shapes when compared to each other.

9. The camera module of claim 1, wherein the number of the marked portions is three, two of the three marked portions are separately formed on one edge of the main body, and positioned at the left side of the first symmetrical axis of the main body; the other one of the three marked portions is oppositely formed on the other opposite edge of the main body, and is positioned at the right side of the first symmetrical axis of the main body.

10. The camera module of claim 1, wherein there are two marked portions symmetrically positioned at two sides of the main body with respect to the first symmetrical axis of the main body, and the marked portions have different shapes.

11. The camera module of claim 1, wherein the marked portion is a notch or indentation at one edge of the main body.

12. The camera module of claim 1, wherein the marked portion is a gap defined through the printed circuit board and communicates with a side surface of the main body.

13. The camera module of claim 1, wherein the marked portion is a through hole defined through the printed circuit board, and is positioned adjacent to one side surface of the main body.

14. A camera module, comprising:
a printed circuit board;
a lens mounted on a top surface of the printed circuit board; and
an electronic connector mounted to a bottom surface of the printed circuit board;
wherein, the printed circuit board comprises a main body and a plurality of marked portions formed on the main body; the main body has a first symmetrical axis lengthwise along the structure of the main body, and a second symmetrical axis perpendicular to the first symmetric axis; the plurality of marked portions are visible from the top or the bottom of the printed circuit board.

15. The camera module of claim 14, wherein the number of the marked portions positioned at two sides of the first symmetrical axis or the second symmetrical axis are of different numbers.

16. The camera module of claim 14, wherein the marked portions positioned at two sides of the first symmetrical axis or the second symmetrical axis are of different shapes.
